(19) United States
(12) Patent Application Publication
(10) Pub. No.: US 2015/0115546 A1
(43) Pub. Date: Apr. 30, 2015

(54) Sealing Structure of Motor Case and Motor

(71) Applicant: Shinano Kenshi Kabushiki Kaisha, Ueda-shi (JP)

(72) Inventor: Akishige UMEMATSU, Ueda-shi (JP)

(21) Appl. No.: 14/509,595

(22) Filed: Oct. 8, 2014

(30) Foreign Application Priority Data
Oct. 28, 2013 (JP) 2013-223503

(51) Int. Cl. F04D 25/06; F04D 29/08; H01R 4/02; F04D 17/08

(52) U.S. Cl. CPC F04D 25/0693; F04D 17/08; F04D 29/083; H01R 4/02
USPC 277/608

(57) ABSTRACT

In the sealing structure, coil leads of motor coils are connected to a bottom part of a motor case, a motor-control board, which has a connector to which lead wires are connected, is attached to the bottom part, the motor case has a connector insertion hole, into which the connector is inserted to expose on the outside of the motor case, and a ring-shaped sealing member, which is fitted on an outer circumferential face of the connector, is sandwiched between a motor-control board and the bottom part of the motor case so as to seal the connector insertion hole.

### CROSS-REFERENCE TO RELATED APPLICATION

This application is based upon and claims the benefit of priority of the prior Japanese Patent Application No. P2013-223503, filed on Oct. 28, 2013, and the entire contents of which are incorporated herein by reference.

### FIELD

The present invention relates to a sealing structure of a motor case and a motor, e.g., blower motor, including a motor case having the sealing structure.

### BACKGROUND

For example, in a blower shown in FIG. 3B, a blower case 52, in which an impeller 51 (see FIG. 3A) is accommodated, and a motor case 53, in which a blower motor M (e.g., outer rotor-type motor) is accommodated, are integrated. As shown in FIG. 4B, a shaft is rotatably held in the blower case 52 and the motor case 53. The impeller 51 is attached to the shaft in the blower case 52, and a rotor 54 is attached to the shaft in the motor case 53. A cylindrical housing 55 is provided to a center of a bottom part of the motor case 53. A stator (not shown) and a motor-control board 56 are attached to the cylindrical housing 55. By actuating the blower motor M, the impeller 51 shown in FIG. 3A is rotated, so that air is sucked into the blower case 52, from an axial direction, via an air inlet 52a, and the compressed air is blown out from an air outlet 52b, which is extended in a tangential direction.

Coil leads of motor coils, which are respectively wound on magnetic pole teeth of a stator core (not shown), are electrically connected to cable patterns, which are formed on one of surfaces of the motor-control board 56 (e.g., an upper surface shown in FIG. 4B), by soldering. Further, lead wires 57 are connected to the other surface of the motor-control board 56 (e.g., a lower surface shown in FIG. 4B), by soldering, screws, etc., so that the lead wires 57 are electrically connected to the cable patterns. The lead wires 57 are outwardly extended to outside of the motor case 54 via an opening part 53a (see FIG. 4A) formed in the bottom part of the motor case 53 (see FIGS. 3B, 4B and 4C.

In the blower motor M shown in FIG. 4B, air tightness of the motor case 53, which is integrated with the blower case 52, must be high so as to maintain fluid pressure generated by rotation of the impeller 51. If a part of the high-pressure fluid leaks from the motor case 53, motor loss must be increased and motor efficiency must be lowered. Therefore, applying a great motor current, whose current value is greater than a previously-set value, to the blower motor M is required. To prevent the leakage of the fluid, a gap between the opening part 53a of the motor case 53 and the lead wires 57, which are outwardly extended through the opening part 53a, must be filled. To fill the gap in the opening part 53a of the motor case 53, a sealing agent, e.g., adhesive, has been used (see Japanese Laid-open Utility Model Publication No. 6-36345) or a rubber bush has been used (see Japanese Laid-open Utility Model Publication No. 62-14952).

Firstly, in case of the sealing method where the sealing agent, e.g., adhesive, is used, the sealing method can be easily performed without using metallic molds, etc., but any means for holding the sealing agent in the periphery of the opening part is required. If the sealing agent is excessively applied, the sealing agent will drop into the motor case 53. On the other hand, if a small amount of the sealing agent is applied, the fluid will leak from the motor case 53. Cure conditions depend on types of the sealing agent. In case of curing by air-drying, it takes a long time to dry and cure the sealing agent. In case of ultraviolet curing, an ultraviolet irradiation apparatus must be prepared.

Further, in case of the sealing method where the rubber bush is used, a process of shaping the bush with metallic molds is required, so a production cost must be increased. And, a gap between adjacent leads wires cannot be sealed by the bush, so seal efficiency must be lowered.

### SUMMARY

The present invention has been performed to solve the above described problems of the conventional technologies. Accordingly, it is an object to provide a sealing structure of a motor case, in which seal efficiency can be improved by sealing a lead wire connecting part of the motor case accommodating a motor for rotating an impeller by a simple manner, and a motor, which has the sealing structure of the present invention and which is capable of reducing motor loss and improving motor efficiency.

To achieve the object, the present invention has following structures.

Namely, in the sealing structure of a motor case of the present invention,

the motor case accommodates a motor for rotating an impeller,

the motor case is integrated with a blower case in which the impeller is accommodated,

a fluid is sucked into the blower case, from an axial direction, and blown out in a tangential direction by rotation of the impeller, and

the sealing structure is characterized in,

that coil leads of motor coils are connected to a bottom part of the motor case,

that a motor-control board, which has a connector to which lead wires are connected, is attached to the bottom part,

that the motor case has a connector insertion hole, into which the connector is inserted to expose outside of the motor case, and

that a ring-shaped sealing member, which is fitted on an outer circumferential face of the connector, is sandwiched between the motor-control board and the bottom part of the motor case so as to seal the connector insertion hole.

With the above described structure, the ring-shaped sealing member is fitted on the outer circumferential face of the connector provided to the motor-control board, and the connector is inserted into the connector insertion hole, which is formed in the bottom part of the motor case, so as to fix the motor-control board, so that a gap in the connector insertion hole, which is formed in the bottom part of the motor case, can be securely sealed by the ring-shaped sealing member.

Therefore, leakage of the fluid from the motor case can be prevented, invasion of moisture (humidity) and foreign matters into the motor case can be prevented, and damaging electronic parts mounted on the motor-control board can be prevented.

Further, in case that a fluid pressure in the motor case is different from external fluid pressure, sound leakage (noise) will be occurred by the fluid leaking through the gap in the connector insertion hole. In the present invention, the sound leakage can be prevented, so quiet operation of the motor can be performed.

Preferably, in the sealing structure, a step-shaped section may be formed in a periphery of the connector insertion hole, which faces the motor-control board, and

the ring-shaped sealing member may be provided to the step-shaped section and sandwiched between the step-shaped section and the motor-control board.

With this structure, the connector insertion hole of the motor case can be sealed by the motor case (the step-shaped section), the ring-shaped sealing member and the connector. Further, the connector is mounted onto and connected to the motor-control board by soldering, so that fluid leakage through connector pins can be highly prevented.

The motor of the present invention comprises a motor case, and

the motor case has the sealing structure of the present invention.

In the motor, a motor current value need not be excessively increased, so that motor loss can be reduced and motor efficiency can be improved.

In the present invention, the sealing structure of the motor case, in which seal efficiency can be improved by sealing the lead wire connecting part of the motor case accommodating the motor for rotating the impeller by the simple manner, and the motor, which has the sealing structure of the present invention and which is capable of reducing motor loss and improving motor efficiency, can be provided.

### BRIEF DESCRIPTION OF THE DRAWINGS

Embodiments of the present invention will now be described by way of examples and with reference to the accompanying drawings.

FIG. 1 A is a plan view of a motor case of a blower of a first embodiment;

FIG. 1 B is a sectional view of the blower having an outer rotor-type motor,

FIG. 1 C is an enlarged view of an encircled part of FIG. 1B;

FIG. 1 D is a bottom view of the blower;

FIG. 2 A is a plan view of a motor case of a blower of a second embodiment;

FIG. 2 B is a sectional view of the blower having an inner rotor-type motor,

FIG. 2 C is an enlarged view of an encircled part of FIG. 2B;

FIG. 2 D is a bottom view of another blower;

FIG. 3 A is a plan view of a conventional blower;

FIG. 3 B is a side view of the conventional blower;

FIG. 4 A is a plan view of the conventional blower;

FIG. 4 B is a sectional view of the conventional blower; and

FIG. 4 C is a bottom view of the conventional blower.

### DESCRIPTION OF THE PREFERRED EMBODIMENTS

Preferred embodiments of the present invention will now be described in detail with reference to the accompanying drawings. In each of the following embodiments, a sealing structure of a motor case of a blower will be explained. The sealing structure of the motor case can be applied to not only blower motors but also other motors requiring fluid-tightness and seal efficiency.

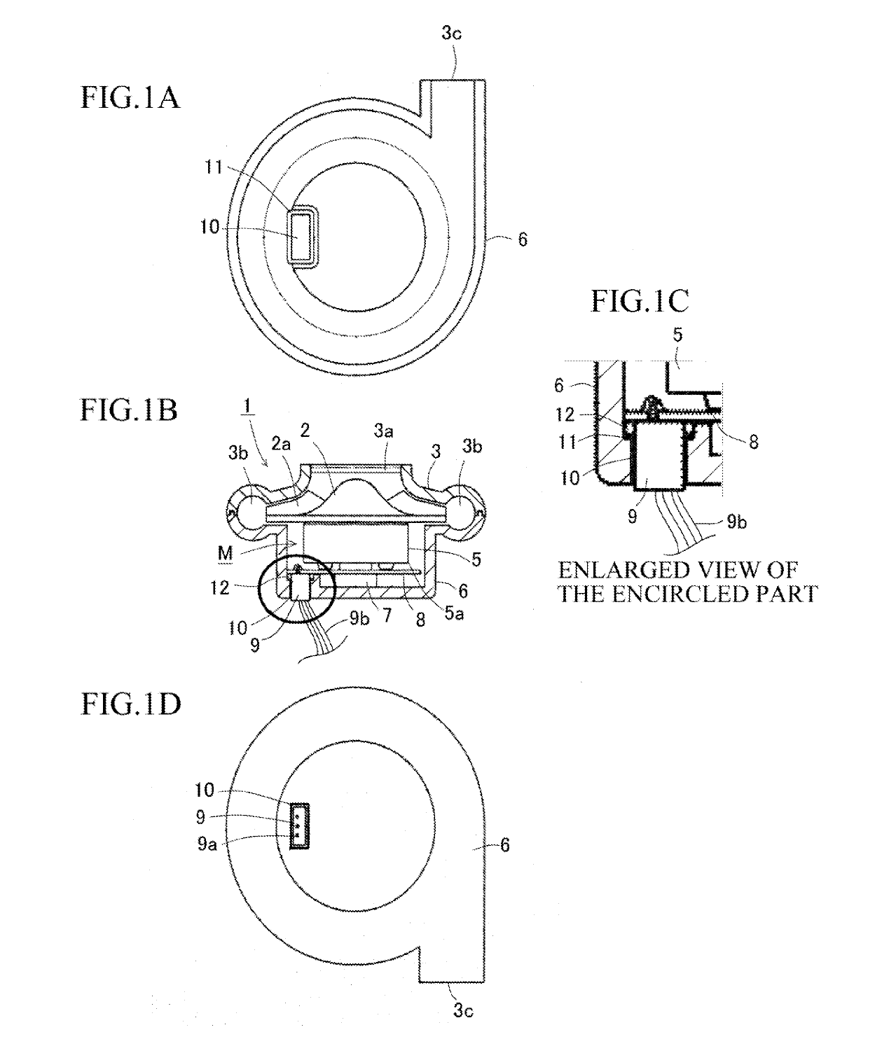

In a first embodiment, the blower 1 has an outer rotor-type motor as a blower motor M. As shown in FIG. 1B, the blower 1 has a blower case 3, in which an impeller 2 is accommodated, and a motor case 6, in which a stator and a rotor 5 (i.e., the blower motor M) is accommodated, and the both cases 3 and 6 are integrated.

In FIG. 1B, an inlet 3a for sucking a fluid (e.g., air) is formed at a center of the blower case 3. Grooves are respectively formed in outer edge parts of the blower case 3 and the motor case 6, and the grooves are faced and overlapped each other. With this structure, a compression chamber (a flow path) 3b is formed. An outlet 3c is formed in outer circumferential faces of the blower case 3 and the motor case 6 and extended in a tangential direction (see FIGS. 1A and 1D). By starting the blower motor M of the blower 1, air is sucked into the blower case 3, from an axial direction, via the inlet 3a, by rotation of the impeller 2, and the compressed air is blown out, in a tangential direction, from the outlet 3c.

The impeller 2 and the rotor 5 are attached to a shaft of the blower motor M. As described above, the impeller 2 is located in the blower case 3, and the rotor 5 is located in the motor case 6. The impeller 2 is fixed to at one end of the shaft by molding, adhesive, press fitting, etc. Blades 2a are radially extended from the impeller 2. The rotor 5 of the outer rotor-type motor includes: a cup-shaped rotor yoke 5a; and a ring-shaped permanent magnet (not shown), which is fixed to an inner circumferential face of the rotor yoke 5a. Magnetic pole teeth are radially extended from a stator core (not shown) and face the permanent magnet of the rotor 5. The stator core is attached to a cylindrical housing 7, which is located at a center of a bottom part of the motor case 6, together with a motor-control board 8. Motor coils are respectively wound on the magnetic pole teeth of the stator core, coil leads extended from the motor coils are electrically connected to cable patterns, which are formed on one of surfaces of the motor-control board 8 (e.g., an upper surface shown in FIG. 1B) by soldering. Further, a connector 9 is connected to the other surface of the motor-control board 8 (e.g., a lower surface shown in FIG. 1B) by soldering, so that the connector 9 is electrically connected to the cable patterns.

In FIG. 1A, a connector insertion hole 10, into which the connector 9 can be inserted, is formed in the bottom part of the motor case 6. A step-shaped section 11 is formed in a periphery of the connector insertion hole 10 formed in the bottom part of the motor case 6. As shown in FIG. 1), a ring-shaped sealing member 12 is fitted on an outer circumferential face of the connector 9. The ring-shaped sealing member 12 may be, for example, an inexpensive O-ring.

The motor-control board 8 is mounted on the bottom part of the motor case 6 by inserting the connector 9 into the connector insertion hole 10, so that the ring-shaped sealing member 12 is fit to the step-shaped section 11. Since the ring-shaped sealing member 12 is sandwiched between the motor-control board 8 and the motor case 6, a gap in the connector insertion hole 10 can be securely sealed.

Namely, the connector insertion hole 10 of the motor case 6 is sealed by the motor case 6 (the step-shaped section 11), the ring-shaped sealing member 12 and the connector 9. Further, the connector 9 is connected to the motor-control board 8 by soldering, so that air leakage through connector pins 9a can be highly prevented. Lead wires 9b are connected to the connector 9.

As described above, the gap in the connector insertion hole 10 can be sealed, with the ring-shaped sealing member 12, by the steps of: fitting the ring-shaped sealing member 12 on the outer circumferential face of the connector 9 of the motor-control board 8; and inserting the connector 9 into the connector insertion hole 10 formed in the bottom part of the motor case 6 to fix.

Therefore, leakage of air from the motor case 6 can be prevented, invasion of moisture (humidity) and foreign matters into the motor case 6 can be prevented, and damaging electronic parts mounted on the motor-control board 8 can be prevented.

A motor current value need not be excessively increased, so that motor loss can be reduced and motor efficiency can be improved.

A mounting position of the motor-control board 8 with respect to the motor case 6 can be determined by the connector 9, so a position of the stator, which has the motor coils connected to the motor-control board 8, is also determined.

Further, in case that air pressure in the motor case 6 is different from external air pressure, sound leakage (noise) will be occurred by the air leakage through the gap in the connector insertion hole 10. In the present invention, the sound leakage can be prevented, so quiet operation of the motor can be performed.

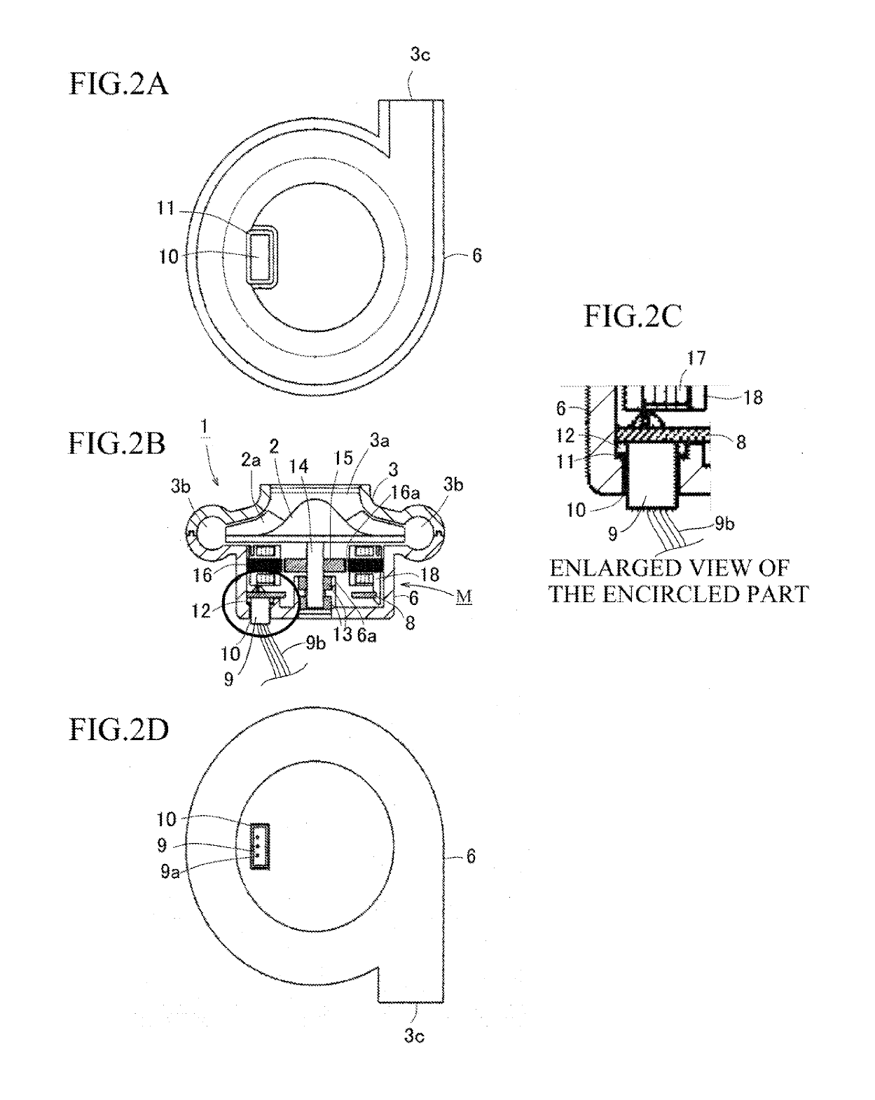

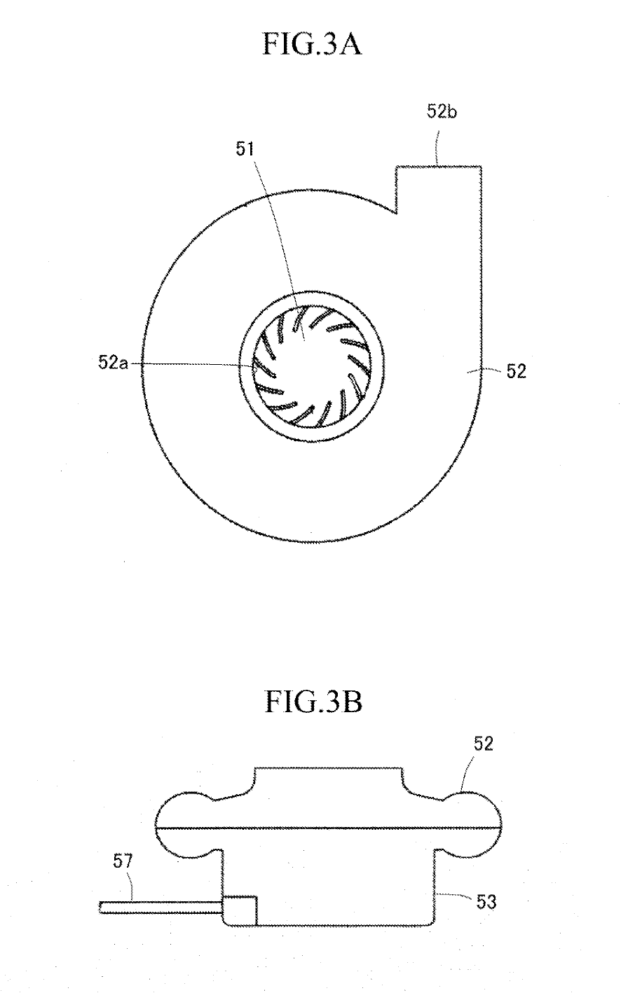

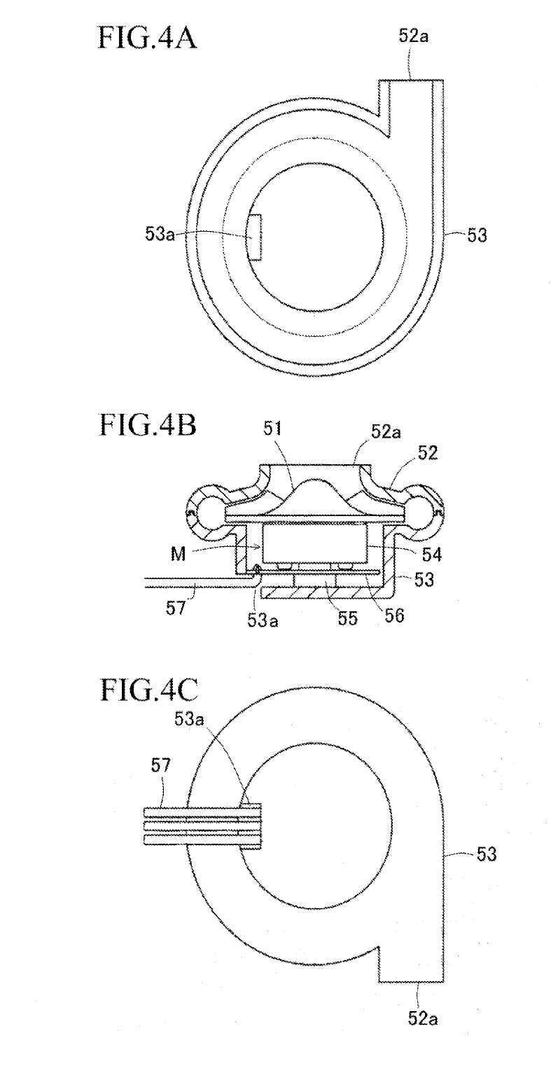

Next, a second embodiment of the sealing structure will be explained with reference to FIGS. 2A-2D. The structural elements shown in the first embodiment are assigned the same symbols, and explanation will be omitted. Differences will be mainly explained. In the first embodiment, the motor is the outer rotor-type motor, but the present invention can be applied to an inner rotor-type motor.

As shown in FIG. 2B, a cylindrical bearing holder 6a is provided to the center of the bottom part of the motor case 6 and erected upward therefrom. A plurality of bearings 13 are provided to the bearing holder 6a, and a shaft 14 is rotatably held by the bearings 13. A disc-shaped permanent magnet 15 is integrated with the shaft 14. A stator core 16 is fixed on an inner face of the motor case 6. Magnetic pole teeth 16a are radially extended, toward the shaft 14, from the stator core 16. Motor coils 17 are respectively wound on the magnetic pole teeth 16 through an insulator 18. The motor-control board 8 is attached to and held by the insulator 18 and the bottom part of the motor case 6. Coil leads of the motor coils 17 are electrically connected to the cable patterns, which are formed on one of the surfaces of the motor-control board 8 (e.g., the upper surface shown in FIG. 2B) by soldering, as well as the first embodiment. Further, the connector 9 is connected to the other surface of the motor-control board 8 (e.g., a lower surface shown in FIG. 2B) by soldering, so that the connector 9 is electrically connected to the cable patterns, as well.

The connector 9 is inserted into the connector insertion hole 10 (see FIG. 2D), and the motor-control board 8 is held by the insulator 18 and the bottom part of the motor case 6 (see FIG. 2B). With this structure, the ring-shaped sealing member (e.g., O-ring) 12 is set in the step-shaped section 11 (see FIG. 2A). By sandwiching the ring-shaped sealing member 12 between the motor-control board 8 and the motor case 6, the gap in the connector insertion hole 10 can be sealed, as well as the first embodiment. Namely, the connector insertion hole 10 formed in the motor case 6 can be sealed by the motor case 6, the ring-shaped sealing member 12 and the connector 9 (see FIG. 2C).

In each of the above described embodiments, the motor M, which is the outer rotor- or inner rotor-type motor, is the blower motor, but the present invention may be applied to other motors requiring seal efficiency.

Further, in each of the above described embodiments, the coil leads of the motor coils 17 are connected to one of the surfaces of the motor-control board 8, and the connector 9 is connected to the other surface thereof. But, in the present invention, the coil leads and the connector may be connected to the same surface.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alternations could be made hereto without departing from the spirit and scope of the invention.

What is claimed is:

1. A sealing structure of a motor case,
wherein the motor case accommodates a motor for rotating an impeller,
the motor case is integrated with a blower case in which the impeller is accommodated, and
a fluid is sucked into the blower case, from an axial direction, and blown out in a tangential direction by rotation of the impeller, and
the sealing structure being characterized in,
that coil leads of motor coils are connected to a bottom part of the motor case,
that a motor-control board, which has a connector to which lead wires are connected, is attached to the bottom part,
that the motor case has a connector insertion hole, into which the connector is inserted to expose on the outside of the motor case, and
that a ring-shaped sealing member, which is fitted on an outer circumferential face of the connector, is sandwiched between the motor-control board and the bottom part of the motor case so as to seal the connector insertion hole.

2. The sealing structure according to claim 1,
wherein a step-shaped section is formed in a periphery of the connector insertion hole, which faces the motor-control board, and
the ring-shaped sealing member is provided to the step-shaped section and sandwiched between the step-shaped section and the motor-control board.

3. A motor,
comprising a motor case,
wherein the motor case has the sealing structure according to claim 1.

4. A motor,
comprising a motor case,
wherein the motor case has the sealing structure according to claim 2.
